(19) United States
(12) Patent Application Publication
(10) Pub. No.: US 2026/0298562 A1
(43) Pub. Date: Oct. 1, 2026

(54) GRAPHENE HEAT TRANSFER

(71) Applicant: Graphene Manufacturing Group Ltd, Richlands (AU)

(72) Inventor: Craig Nicol, Enoggera (AU)

(21) Appl. No.: 19/708,260

(22) Filed: Jun. 15, 2026

Related U.S. Application Data
(63) Continuation-in-part of application No. 19/121,221, filed on Nov. 17, 2023.

(30) Foreign Application Priority Data
Dec. 5, 2022 (AU) 2022903710
Dec. 21, 2022 (AU) 2022903937
Jun. 1, 2023 (AU) 2023901730
Jun. 16, 2025 (AU) 2025204478

(51) Int. Cl. F28F 13/18; C08K 3/04; C09D 5/02; C09D 5/18; C09D 7/40; C09D 7/45; C09D 7/61; C09D 7/80; C09D 133/06; C09K 5/14

(52) U.S. Cl. CPC F28F 13/182; C09D 5/022; C09D 5/028; C09D 5/18; C09D 7/45; C09D 7/61; C09D 7/67; C09D 7/68; C09D 7/69; C09D 7/80; C09D 133/068; C09K 5/14; C08K 3/042; C08K 2201/001; C08K 2201/005; C08K 2201/011; F28F 2215/00

(57) ABSTRACT

The present invention relates to a heat exchanger. The heat exchanger comprises a substrate having a thermally conductive coating of graphene nanoparticles applied to at least a first surface thereof. The graphene nanoparticles are derived from a carbon gas. One or more tubes are provided for carrying fluid

### COLOR DRAWING STATEMENT

The patent or application file contains at least one drawing executed in color. Copies of this patent or patent application publication with color drawing(s) will be provided by the Office upon request and payment of the necessary fee.

### FIELD

This invention relates to graphene coatings for use in improved heat transfer, and particularly high purity graphene including graphene nanoplatelets and graphene nanoparticles derived from carbon containing gas. The invention also relates to methods of forming such coatings.

### BACKGROUND

Heat exchangers are important for removing heat from one location to another. For example, heat exchangers find common use in industrial settings for heating or cooling industrial streams. In other examples, heat exchangers find common use as components of electrical equipment for cooling electrical components which heat during use. It is desirable to provide heat exchange surfaces that have high heat transfer properties to facilitate heat exchange.

It is an object of the invention to address one or more shortcomings of the prior art and/or provide a useful alternative.

Reference to any prior art in this specification is not, and should not be taken as, an acknowledgement or any form of suggestion that the prior art forms part of the common general knowledge of a person skilled in the art.

As used herein, except where the context requires otherwise, the term “comprise” and variations of the term, such as “comprising”, “comprises” and “comprised”, are not intended to exclude further additives, components, integers or steps.

### SUMMARY OF INVENTION

According to the present invention, there is provided a heat exchanger comprising:
a substrate having a thermally conductive coating of graphene nanoparticles applied to at least a first surface thereof, wherein the graphene nanoparticles are derived from a carbon gas; and
one or more tubes for carrying fluid.

Advantageously, the heat exchanger need not have a fan thereby reducing potential maintenance issues.

The heat exchanger includes a heat exchange wall including the substrate. The substrate may permit the passage of air onto the tubes. The substrate may be ribbed or finned. The substrate may permit the passage of air onto the tubes. The heat exchanger may include a shell including the wall. The shell may have a quadrilateral cross section. The shell may surround the tubes. Each tube may be serpentine.

In a first aspect of the disclosure there is provided a coating composition comprising graphene nanoparticles derived from a carbon gas and one or more dispersing agents dispersed in an emulsion or a resin.

In an embodiment, the composition includes graphene nanoparticles in an amount equal to or less than a wt % value selected from the group consisting of: 0.01%, 0.05%, 0.10%, 0.5%, 1%, 2%, 3%, 5%, 10%, 20%, 30%, 50%, by weight of graphene nanoparticles. Alternatively, or additionally, the composition comprises graphene nanoparticles in an amount equal to or greater than a wt % value selected from the group consisting of: 0.01%, 0.05%, 0.10%, 0.5%, 1%, 2% by weight of graphene nanoparticles. In preferred forms of the above embodiments, the composition comprises graphene nanoparticles in amount of from about 0.01 wt % to about 50 wt %.

In an embodiment, the graphene nanoparticles are in the form of particles or platelets or flakes with a size in the range of 2 nm to 100 microns.

In an embodiment the dispersing agents are selected from the group consisting of anionic, nonionic, cationic dispersants or additives, and combinations thereof.

In an embodiment, the emulsion or resin comprises one or more additives selected from the group consisting of anionic, nonionic, cationic dispersants or additives, and combinations thereof.

In an embodiment, the graphene nanoparticles are in the form of solid flakes or powders.

In an embodiment, the emulsion has a primary phase, and the primary phase or the resin is selected from the group consisting of acrylic, acrylic and epoxy, acrylic epoxy copolymer, styrene acrylic, polyurethane, epoxy, ethyl silicate, polysiloxane, polyurea, saturated or unsaturated polyester, polyaspartic, and combinations thereof.

In an embodiment, the composition has a viscosity of about 50 s to about 70 s as measured using a Zhan type cup no. 2. Preferably the viscosity is about 55 s to about 65 s. The inventors have found that this viscosity is useful since it allows the composition to be readily applied onto a surface using a variety of coating techniques whilst also forming a cohesive coating that is substantially free of defects.

In an embodiment, the composition has a pH greater than 7. Preferably the pH is from about 7 to 11. More preferably, the pH is from about 7.5. Most preferably, the pH is from about 8. Additionally or alternatively, it is preferred that the pH is up to about 10.5. Most preferably, the pH is up to about 10.

In an embodiment, the composition has a density of greater than 1 kg/L. Preferably the density is greater than 1.05 kg/L. Most preferably, the density is greater than 1.10 kg/L. Additionally or alternatively, the suspension has a density of up to 1.2 kg/L. Most preferably, up to about 1.15 kg/L.

In an embodiment, the emulsion or resin is not and/or does not comprise a base oil, a lubricant, a lubricating oil, a grease, or a coolant.

In a second aspect of the disclosure, there is provided a method for producing a graphene containing suspension for use as a coating, the method including:
combining the graphene nanoparticles derived from a carbon gas with one or more dispersing agents to form a combination; and
mixing the combination with an emulsion or resin to form the suspension for use as the coating.

In an embodiment, the graphene nanoparticles are derived from a carbon gas and one or more other carbon containing precursors including graphite, carbon black, activated carbon and hard and soft carbons; graphene derived from gas, graphene derived from graphite, graphene oxide derived from graphite, modified carbon, carbon black or a composite of various carbon nanostructures. The carbon source may be graphite, gas and liquids containing carbon, and or biosolid feedstock.

In an embodiment, the method comprises combining the graphene nanoparticles in an amount equal to or less than a wt % value selected from the group consisting of: 0.01%, 0.05%, 0.10%, 0.5%, 1%, 2%, 3%, 5%, 10%, 20%, 30%, 50%, by weight of graphene nanoparticles. Alternatively, or additionally, combining the graphene nanoparticles in an amount equal to or greater than a wt % value selected from the group consisting of: 0.01%, 0.05%, 0.10%, 0.5%, 1%, 2%, 3%, 5%, 10%, 20%, 30% by weight of graphene nanoparticles. In preferred forms of the above embodiments, the method comprises combining the graphene nanoparticles in amount of from about 0.01 wt % to about 50 wt %. The weight % values are preferably based on the total weight of the coating composition.

In an embodiment, the graphene nanoparticles are in the form of particles or platelets or flakes with a size in the range of 2 nm to 100 microns.

In an embodiment, the graphene nanoparticles are in the form of solid flakes or powders.

In an embodiment the dispersing agents are selected from the group consisting of anionic, nonionic, cationic dispersants or additives, and combinations thereof.

In an embodiment, the emulsion or resin comprises one or more additives selected from the group consisting of anionic, nonionic, cationic dispersants or additives, and combinations thereof.

In an embodiment the step of mixing comprises high shear mixing with a shear rate of 10,000 s⁻¹ or greater. Preferably the shear rate is from about 40,000 to about 60,000 s⁻¹. Preferably, the step of mixing is conducted for a time of from about 3 minutes to about 72 hours. More preferably, the mixing time is from about 1 to about 4 hours. The shear rate and mixing time are dependent upon varying dispersion and distribution combinations. However, the inventors have found that this shear rate and/or time is useful to disperse and distribute the graphene nanoparticles into the emulsion or resin.

In an embodiment, the step of mixing is carried out using a ball mill or bead mill or a jet mill or other milling equipment.

In an embodiment, the emulsion has a primary phase, and the primary phase or the resin is selected from the group consisting of acrylic, acrylic and epoxy, acrylic epoxy copolymer, styrene acrylic, polyurethane, epoxy, ethyl silicate, polysiloxane, polyurea, saturated or unsaturated polyester, polyaspartic, and combinations thereof.

In an embodiment, the suspension has a viscosity of about 50 s to about 70 s as measured using a Zhan type cup no. 2. Preferably the viscosity is about 55 s to about 65 s.

In an embodiment, the emulsion or resin is not and/or does not comprise a base oil, a lubricant, a lubricating oil, a grease, or a coolant.

In a third aspect of the disclosure there is provided a heat exchange wall or a heat exchanger comprising a substrate having a thermally conductive coating of graphene nanoparticles applied to at least a first surface thereof, wherein the graphene nanoparticles are derived from a carbon gas. The heat exchange wall may have a second surface in conductive contact with the first surface. The substrate may be metal, plastic or any other heat conducting surface. Preferably, the second surface is in thermal conductive contact with the first surface.

The heat exchange wall may be in the form of a shell, tube, plate, baffle, coil, fin, or other such heat exchange surfaces that are commonly used in heat exchangers or heat exchange devices.

In an embodiment, the coating is a coating according to the first aspect of the invention and/or embodiments and/or forms thereof.

In an embodiment, the coating is formed according to the method of the second aspect of the invention and/or embodiments thereof.

In one embodiment, the coating of graphene nanoparticles is configured to receive heat from the substrate and transmit or otherwise conduct heat from the substrate. In an alternative embodiment, the coating of graphene nanoparticles is configured to receive heat from a heat source and conduct heat to the substrate.

In an embodiment, the substrate is a thermally conductive material, and the heat exchange wall is configured such that heat is received by a second surface and is conducted through the substrate to the first surface. In one form the second surface is substantially free of the conductive coating of graphene nanoparticles. However, in an alternative form, the second surface has a conductive coating of graphene nanoparticles applied thereto.

In a fourth aspect of the disclosure, there is provided a method of preparing a heat exchange surface, the method comprising: coating a surface of a substrate with a layer of graphene nanoparticles, wherein the graphene nanoparticles are derived from a carbon gas. The substrate may be metal, plastic or any other heat conducting surface.

In an embodiment, the step of coating the surface comprises applying one or more layers of the graphene containing suspension of the first aspect of the invention and/or embodiments and/or forms thereof, to the surface to form a coating thereon.

In an embodiment, the step of coating the surface comprises applying one or more layers of the graphene containing suspension formed according to the method of the second aspect of the invention and/or embodiments and/or forms thereof to the surface to form a coating thereon.

Preferably, the method further includes drying or curing the graphene containing suspension to form the coating.

In an embodiment, the heat exchange wall is part of a thermal system, and the thermal system comprises apparatus or means for applying vibration and/or strain to the coating of graphene nanoparticles and/or apparatus or means for applying a voltage across the coating of graphene nanoparticles.

In one form of the above embodiment, there is provided a method of operating a thermal system comprising applying vibration and/or strain to the coating of graphene nanoparticles and/or applying a voltage across the coating of graphene nanoparticles. Preferably the method comprises applying heat to a first surface or a second surface thereof.

In yet another aspect of the invention, there is provided a solar panel comprising a thermally conductive material having a coating of graphene nanoparticles applied thereto, wherein the graphene nanoparticles are derived from a carbon containing gas.

In embodiments of the third and fourth aspects of the invention, the coating of graphene nanoparticles is a dried or cured layer of the coating composition of the first aspect of the invention and/or embodiments and/or forms thereof.

In an embodiment, the solar panel has a sun facing surface, and a rear facing surface, and wherein the rear facing surface has the coating of graphene nanoparticles applied thereto. Preferably, the sun facing surface comprises one or more photovoltaic cells.

Further aspects of the present invention and further embodiments of the aspects described in the preceding paragraphs will become apparent from the following description, given by way of example.

### FIGURES

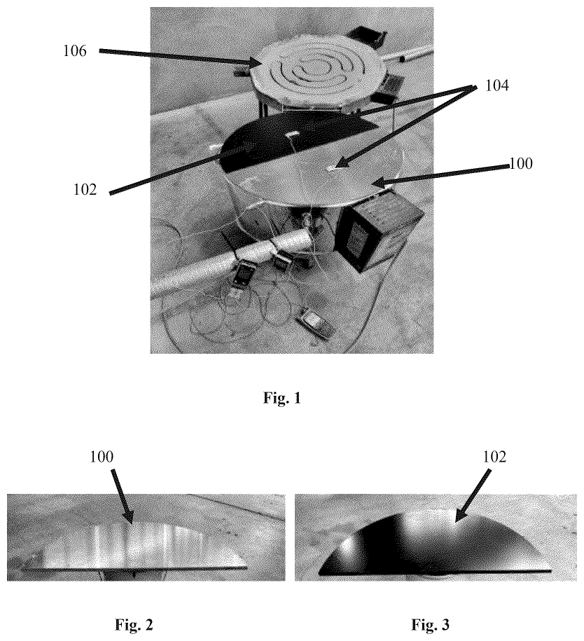

FIG. 1 is a photograph showing an experimental rig for testing the thermal heat transfer and retention properties of a material sample having a coating according to the present invention.

FIG. 2 is a photograph showing an uncoated material sample used in the experimental rig of FIG. 1.

FIG. 3 is a photograph showing a coated material sample used in the experimental rig of FIG. 1.

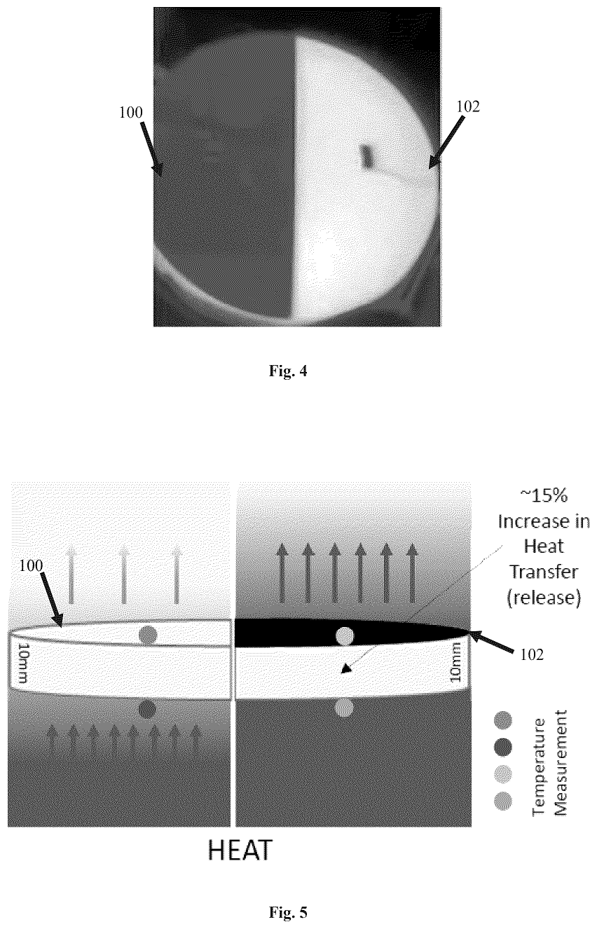

FIG. 4 is a thermal image of an uncoated and coated material during thermal testing in the experimental rig of FIG. 1.

FIG. 5 is an illustration depicting heat transfer in the experimental rig of FIG. 1 for an uncoated material sample as compared with a coated material sample.

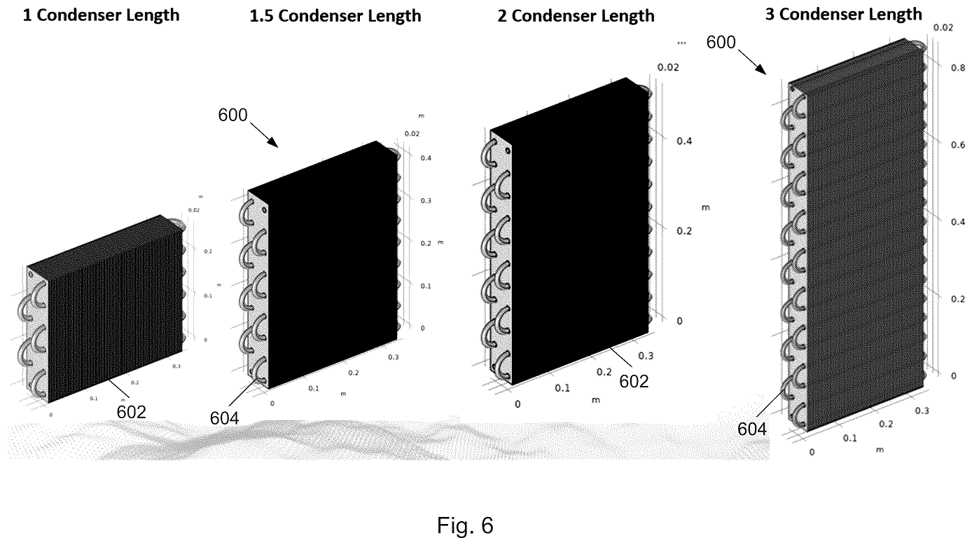

FIG. 6 shows upper perspective views of four condensers of different length used in testing.

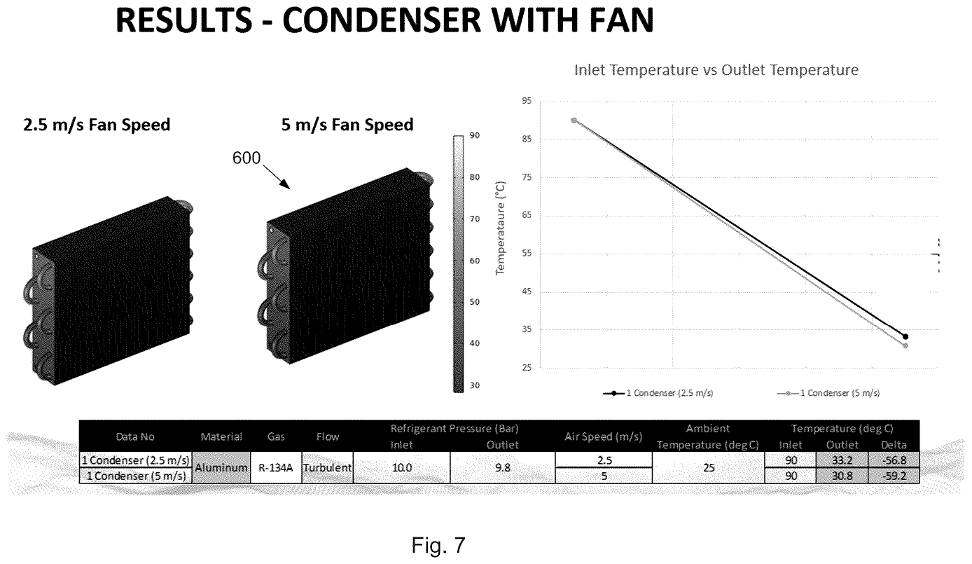

FIG. 7 shows results of using a condenser of FIG. 6 with a fan and no coating.

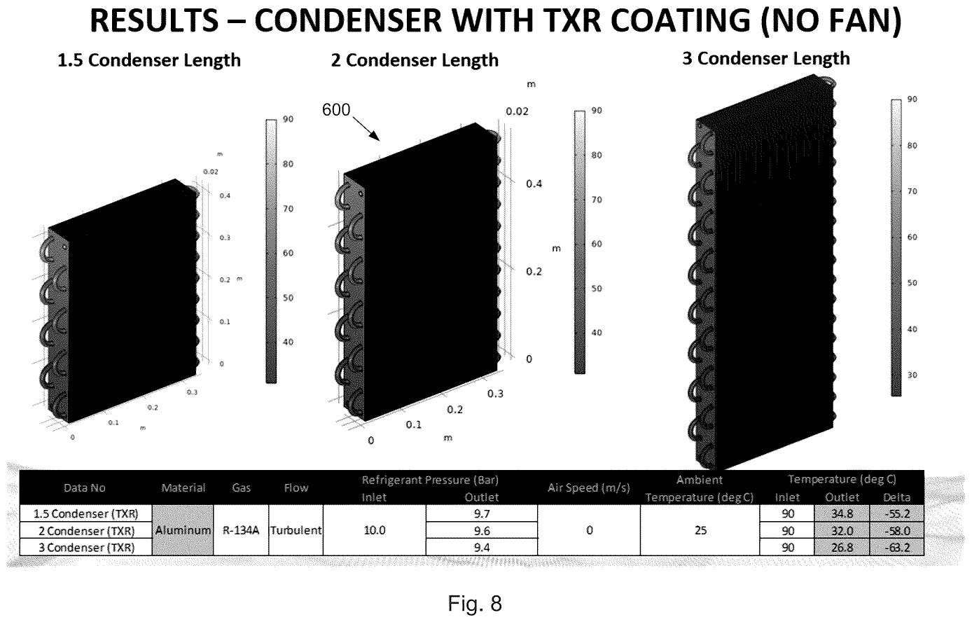

FIG. 8 shows results of using condensers of FIG. 6 with a coating and no fan.

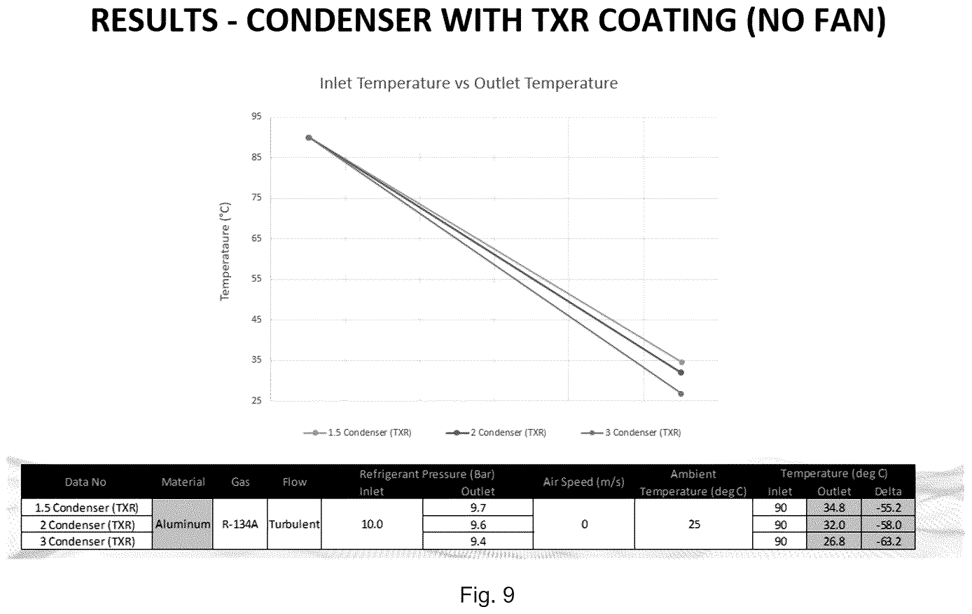

FIG. 9 shows plotted results of FIG. 8.

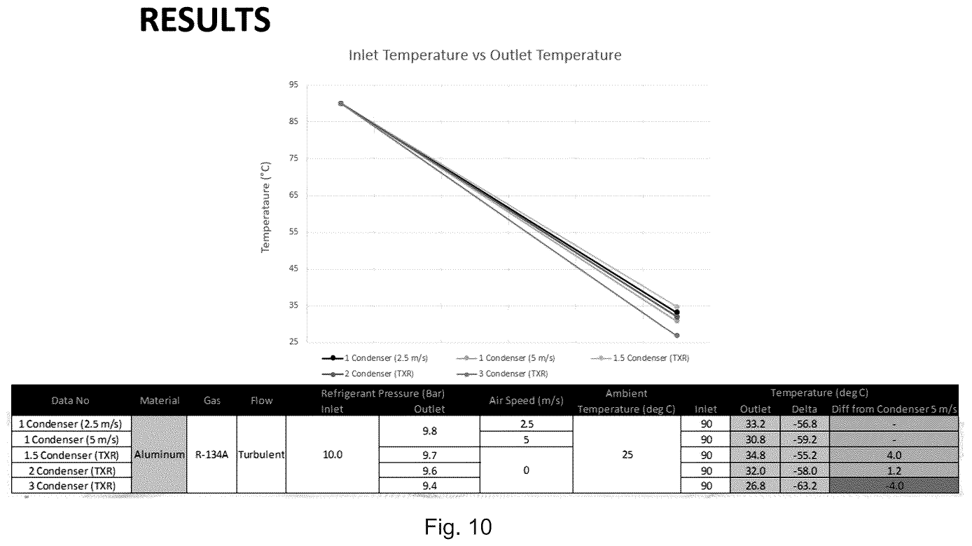

FIG. 10 shows combined results of FIG. 7 (fan and no coating) and FIG. 8 (coating and no fan).

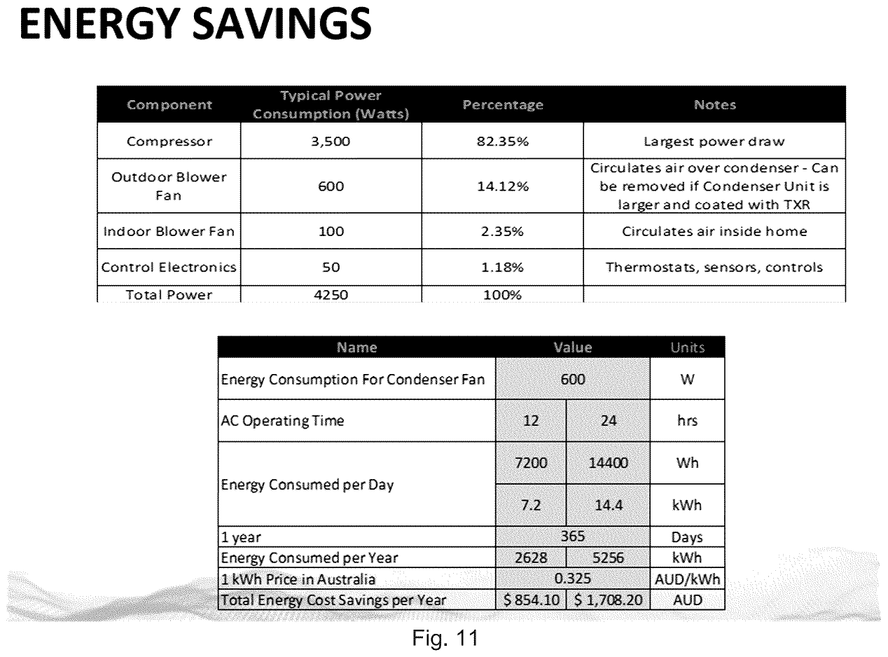

FIG. 11 includes tables showing condenser energy savings using the coating and no fan.

### DESCRIPTION OF EMBODIMENTS

The present invention relates to graphene suspensions for use as coatings, graphene coatings, or graphene coated surfaces to improve and facilitate heat transfer effects. The coating can be applied to improve thermal transmission. The thermal transmission can be enhanced by coating an emissive/radiative surface.

In relation to enhanced thermal transmission, the inventors have found that coating a surface with graphene nanoparticles facilitates highly efficient heat transfer. In particular, the inventors have found that heat exchange surfaces that are coated with graphene nanoparticles are able to facilitate rates of heat transfer generally exceed that possible through standard physical heat transfer mechanisms such as conduction and/or convection. Without wishing to be bound by theory, the inventors are of the view that the graphene coatings of the invention are able to facilitate heat transfer via a quantum heat transfer process, in particular, the inventors understand that the high thermal conductivity of the coatings of the present invention is achieved via a phonon heat transfer mechanism. Phonons are a unit of vibrational energy that arises from oscillating atoms within a crystal. Phonons allow super-conductor-like properties, that store and remove heat.

The inventors have found that high purity graphene nanoparticles are important for achieving highly efficient heat transfer (such as via quantum heat transfer processes). In particular, the inventors have found that impurities in graphene inhibit or prevent efficient heat transfer. To this end, the inventors have found that graphene derived from a carbon containing gas produces a high-quality graphene that is substantially free of impurities, and as such, this graphene is able to be used as a graphene coating to facilitate highly efficient heat transfer. The term carbon containing gas is intended to refer to gases containing carbon, e.g. in molecular form. By way of example, carbon containing gases include hydrocarbon gases such as methane, ethane, propane and the like.

Graphene derived from a carbon containing gas is different from graphene that is produced from graphite. Typical approaches to producing graphene from graphite include physical processes such as the micro-mechanical exfoliation of graphite or chemical processes such as the modified Hummer's method.

Exfoliation of graphite produces graphene by sloughing graphene layers from graphite. One issue with this method is that the resultant graphene includes any impurities that are present in the parent graphite, such impurities include Fe, Co, Cu, Mo, Ni, and Si (and oxides thereof). As noted above, the presence of these impurities has a deleterious effect on the heat transfer process and as such, is undesirable in a graphene coating for facilitating heat transfer.

Modified Hummer's method involves the chemical oxidation of graphite to graphene oxide (GO). The graphene oxide can then be chemically reduced to a reduced graphene oxide (rGO). Briefly, the method includes treating graphite with an oxidising solution which may for example include potassium permanganate, sulfuric acid, and hydrogen peroxide to convert the graphite to graphene oxide. Graphene oxide contains oxidized functional groups such as hydroxyl, epoxy, and carboxyl groups. The graphene oxide may then be reduced to rGO using methods known to those skilled in the art, e.g. chemical, thermal, or electrochemical processes. Whilst this reduction process is suitable to reduce the overall density of oxidized functional groups, the resultant rGO still includes oxidized functional groups. Further, the use of various chemical reagents to promote the conversion of graphite to graphene/GO/rGO also adds chemical impurities to the resultant graphene/GO/rGO. The presence of graphene oxide, reduced graphene oxide, these oxidized functional groups, or these chemical impurities likewise reduces the effectiveness of the heat transfer properties of the graphene.

The graphene coatings can be applied to a surface via a range of coating technologies including both dry and wet coating techniques. Wet coating techniques, such as spraying, or dip coating are preferred.

Dry coating techniques generally involve forming a graphene powder of graphene particles derived from a carbon containing gas. This graphene powder may then be coated on to a surface via a number of different coating techniques including physical vapor deposition, powder coating, or electrostatic deposition. After the surface is coated, the surface may then be subjected to a treatment process to cure, anneal, or otherwise set the coating.

Wet coating techniques generally involve forming a suspension of graphene particles derived from a carbon containing gas in a carrier liquid to form a coating solution, applying that coating solution to a surface, and then removing the carrier liquid to form the coating. The coating may then be subjected to a treatment process to cure, anneal, or otherwise set the coating. The coating may be applied using a variety of coating technologies, a non-limiting disclosure of which includes spin coating, dip coating, drop casting, spray coating, doctor blading, gravure printing, and the like. Preferred coating techniques include spray coating and dip coating.

The graphene coating may be applied to a range of different materials. However, since the objective is to provide a surface having improved heat transfer effects, the graphene coating will typically be applied to the surface of a thermally insulative or conductive material, such as aluminium, iron, steel, copper, metal nitrides or carbides, plastic and composite materials.

In various examples, the graphene nanoparticle coating is applied to or forms part of a heat exchange surface of a heat exchanger, such as: (i) on tube walls of double tube heat exchangers, tube in tube heat exchangers, or shell and tube heat exchangers, (ii) on surfaces of plate heat exchangers, or (iii) on heat exchange surfaces such as fins or baffles. In other examples, the graphene nanoparticle coating may be applied to or form part of a heat exchange surface in the form of a heat sink for passively cooling e.g. electronic components.

The graphene coating is generally in the form of a thin layer ranging from 2 microns to 20 microns in thickness of graphene nanoparticles with size ranging from 2 nm to 100 microns (preferably e.g. 50 microns, 40 microns, 30 microns, 20 microns, 10 microns). The morphology of the graphene nanoparticles includes spherical, crumpled, sheet like and platelet like structures.

The inventors have found that the heat transfer effects provided by the graphene coatings of the invention can be further enhanced by applying strain, vibrations, or a voltage across the graphene coating. In this way, the heat transfer effects provided by the graphene coatings of the invention can be further enhanced.

In still other embodiments, the inventors have found that the graphene suspension has application in solar energy generation systems. Solar energy generation is important for a clean and green environment. It is known that when operating solar conversion systems, such as photovoltaic panels over a recommended optimum temperature, e.g. 25 degree Celsius, the power conversion efficiency of the solar panels drops. The inventors have found that power outputs can be maintained or increased at temperatures by keeping the panels cooler.

In view of the above, the inventors have applied the graphene suspension to form a coating onto the rear side of a working solar panel. This solar panel may be a newly fabricated solar panel or could be applied to an existing solar panel in operation. The inventors have found that a useful amount of coating ranges from a few hundred milliliters to a thousand milliliters for six to ten square meters. The resultant coated panels were found to be cooler in the range of 5% to 25% (in degree Celsius) with an observed power increase ranging from 0.5% to 5% (in Watts).

### EXAMPLE

This example reports the results of thermal emissivity of graphene coatings obtained from a series of experiments.

In this example, two metal test plates of aluminium were prepared with one plate coated on the top side with a graphene coating according to the invention and the other sheet left bare. Each pair of the metal test plates were cut from the same parent plate to minimise variance in metal conductivity.

Wet coatings were applied to the metal test plates in the form of solutions of 15-30 wt % acrylic epoxy polymer, and 2-5 wt % graphene with an average particle diameter of about 100 nm. The graphene was derived from a carbon containing gas. Dispersants used included low molecular weight dispersants, oligomeric dispersants, high molecular weight dispersants, and/or polycarboxylic (co)-polymers. To prepare the solution, the mixture of acrylic epoxy copolymer was combined with graphene, and then the resulting combination was mixed with dispersants and subjected to high shear mixing at a shear rate of from about 40,000 to about 60,000 s⁻¹ for a time of 1-4 hrs.

Wet coatings were applied to form dry coatings having a thickness of from about 4 to about 14 nm. In a typical embodiment, the dry film thickness of graphene enhanced coating ranges from 7 to 30 microns.

Calibrated thermocouples were attached to each sheet in the same relative locations.

The metal plates were placed side-by-side with a millimeter size air gap therebetween and over a kiln operated at a temperature of 150° C. which heats the plates to temperatures between 70° C. and 90° C. This was to ensure that the plates were subjected to the same environmental conditions during testing whilst preventing direct contact between the plates to avoid conductive heat transfer between the metal plates. FIG. 1 shows the experimental set up.

FIG. 1 illustrates aluminium plate 100 and graphene coated aluminium plate 102 sitting side by side with thermocouples 104 applied to external surfaces thereof. Kiln 106 is shown beside plates 100 and 102. During testing, plates 100 and 102 are placed over kiln 106 with an air gap therebetween. The plates were rotated over the kiln to ensure observed effects were not from a variance in heater output.

FIG. 2 and FIG. 3 are photographs of aluminium plate 100 and graphene coated aluminium plate 102 respectively. As can be seen, aluminium plate 100 has a bare external surface whereas the external surface of plate 102 is coated with graphene.

FIG. 4 is a thermal image of the metal plates taken during the test. Uncoated aluminium plate 100 is shown on the left-hand side and graphene coated aluminium plate 102 is shown on the right-hand side. As can be seen, there is greater thermal emissivity from graphene coated aluminium plate 102. Measurements indicated that the exterior surface of graphene coated aluminium plate 102 was lower than that of bare aluminium plate 100 and that there was up to 15% increase in heat transfer/release from coated aluminium plate 102 as compared with bare aluminium plate 100. The results are depicted in FIG. 5.

The same experiments were repeated using copper plates. In this case, the graphene coated copper plates exhibited an increase in heat transfer/release of up to 17%. Experiments were also conducted by coating the bottom side and both sides. The results of both series of experiments are summarised in Table 1.

TABLE 1
Summary of results of thermal experiments

| Operating temperature of | | |
|---|---|---|
| between 70° C. and 90° C. | Aluminium | Copper |
| Top side | −15% | −17% |
| Bottom side | +17% | +25% |
| Both sides coated | +5% | +11% |

From the results it can be seen that coating the top side results in increased heat transfer with the coated aluminium plate exhibiting 15% increased heat transfer as compared with the bare aluminium plate and 17% increased heat transfer for the coated copper plate as compared with the bare copper plate. However, coating the bottom side of the plates (i.e., the surface exposed directly to the kiln resulted in a decrease in thermal transmission with a 17% reduction in heat transfer for the aluminium plates and 25% reduction for the copper plates. This suggests that the coating can be applied either to enhance thermal insulation or conduction depending on which surface is coated. Coating both surfaces yielded a moderate insulating effect with a 5% reduction in thermal transmission for the aluminium plates and an 11% reduction in thermal transmission for the copper plates.

According to an embodiment of the present invention, there is provided four heat exchangers 600, in the form of condensers, of four different lengths for testing.

Each heat exchanger 600 comprises a front heat exchange wall 602 including a substrate, and an identical rear heat exchange wall. The substrate has a thermally conductive coating (referenced as “TXR” in some Figures) of graphene nanoparticles applied to at least a first surface thereof. As before, the graphene nanoparticles are derived from a carbon gas.

Each heat exchanger 600 also includes one or more tubes 604 for carrying refrigerant fluid. The vented substrate is ribbed or finned, and can permit the passage of forced air from an external fan onto the tubes 604. However, advantageously, the heat exchanger 600 with a coated substrate need not have a fan thereby reducing potential maintenance issues.

Each heat exchanger includes a shell 600 of quadrilateral cross section, including the wall 602 and surrounding the serpentine tubes 604. The condenser tubes 604 typically carry a hot refrigerant fluid internally and air forms a coolant or condensing medium externally. The purpose of the condenser tubes 604 is to facilitate efficient heat transfer, allowing the refrigerant fluid to cool and condense into a liquid, while the air absorbs the heat.

FIG. 7 shows reference results of using a condenser of FIG. 6 with a cooling fan running at two different fan speeds, with no coating applied. The fan forces air through the front and back wall substrates and onto the tubes 604.

FIG. 8 shows results of using condensers of FIG. 6 with the coating applied to the front and back wall substrates and with no fan.

FIG. 9 shows the plotted results of FIG. 8.

FIG. 10 shows combined results of FIG. 7 (no coating and fan) and FIG. 8 (coating and no fan).

FIG. 11 includes tables showing condenser energy savings using the coating and no fan. Using the coating provides 5-15% energy saving, and also results in higher efficiency heat transfer as before.

It will be understood that the invention disclosed and defined in this specification extends to all alternative combinations of two or more of the individual features mentioned or evident from the text or drawings. All of these different combinations constitute various alternative aspects of the invention.

The term ‘comprise’ and variants of the term such as ‘comprises’ or ‘comprising’ are used herein to denote the inclusion of a stated integer or stated integers but not to exclude any other integer or any other integers, unless in the context or usage an exclusive interpretation of the term is required.

Any reference to publications cited in this specification is not an admission that the disclosures constitute common general knowledge.

1. A heat exchanger, comprising:
a substrate having a thermally conductive coating of graphene nanoparticles applied to at least a first surface thereof, wherein the graphene nanoparticles are derived from a carbon gas; and
one or more tubes for carrying fluid.

2. The heat exchanger of claim 1, wherein the graphene nanoparticles are derived from a carbon gas and from one or more other carbon containing precursors selected from the group consisting of graphite, carbon black, activated carbon, hard carbons, soft carbons, graphene derived from gas, graphene derived from graphite, graphene oxide derived from graphite, modified carbon, carbon black, and a composite of various carbon nanostructures.

3. The heat exchanger of claim 1, wherein the graphene nanoparticles are present:
in an amount equal to or less than a wt % value selected from the group consisting of: 0.01%, 0.05%, 0.10%, 0.5%, 1%, 2%, 3%, 5%, 10%, 20%, 30%, and 50%;
in an amount equal to or greater than a wt % value selected from the group consisting of: 0.01%, 0.05%, 0.10%, 0.5%, 1%, and 2%; and/or
in an amount of from about 0.01 wt % to about 50 wt %.

4. The heat exchanger of claim 1, wherein the graphene nanoparticles are in the form of particles, platelets, or flakes with a size in a range of 2 nm to 100 microns.

5. The heat exchanger of claim 1, wherein the graphene nanoparticles are combined with one or more dispersing agents in an emulsion or a resin comprising acrylic, epoxy, or combinations thereof.

6. The heat exchanger of claim 5, wherein:
the one of more dispersing agents are selected from the group consisting of anionic, nonionic, cationic dispersants or additives, and combinations thereof; and/or
the emulsion or resin comprises one or more additives selected from the group consisting of anionic, nonionic, cationic dispersants or additives, and combinations thereof.

7. The heat exchanger of claim 5, wherein the emulsion has a primary phase, and the primary phase or the resin is selected from the group consisting of acrylic, acrylic and epoxy, acrylic epoxy copolymer, styrene acrylic, epoxy, and combinations thereof.

8. The heat exchanger of claim 1, wherein:
the thermally conductive coating has a viscosity of about 50 s to about 70 s as measured using a Zhan type cup no. 2;
the thermally conductive coating has a pH greater than 7; and/or
the thermally conductive coating has a density of greater than 1 kg/L.

9. The heat exchanger of claim 1, wherein the thermally conductive coating is applied to at least the first surface thereof, wherein:
a) the thermally conductive coating is configured to receive heat from the substrate; or
b) the thermally conductive coating is configured to transfer heat to the substrate.

10. The heat exchanger of claim 1, wherein the thermally conductive coating is applied to at least two surfaces thereof, wherein the thermally conductive coatings are configured to either receive heat from the substrate or transfer heat to the substrate.

11. The heat exchanger of claim 1, wherein the thermally conductive coating is prepared by a method comprising:
combining the graphene nanoparticles derived from the carbon gas with one or more dispersing agents to form a combination; and
mixing the combination with an emulsion or resin comprising acrylic, epoxy, or combinations thereof to form the coating, optionally wherein:
a) the mixing comprises high shear mixing with a shear rate of 10,000 s⁻¹ or greater, and/or at a shear rate of from about 40,000 to about 60,000 s⁻¹;
b) the mixing is conducted for a time of from about 3 minutes to about 72 hours, and/or from about 1 to about 4 hours; and/or
c) the mixing is carried out using a ball mill or bead mill or a jet mill or other milling equipment.

12. The heat exchanger of claim 1, wherein the coated first surface has higher efficiency heat transfer than the uncoated first surface.

13. The heat exchanger of claim 1, further comprising a heat exchange wall including the substrate.

14. The heat exchanger of claim 1, wherein the substrate is ribbed or finned.

15. The heat exchanger of claim 1, further comprising a shell including the wall.

16. The heat exchanger of claim 15, wherein the shell has a quadrilateral cross section.

17. The heat exchanger of claim 15, wherein the shell surrounds the one or more tubes.

18. The heat exchanger of claim 1, wherein each of the one or more tubes is serpentine.

19. The heat exchanger of claim 1, wherein the substrate permits the passage of air therethrough onto the one or more tubes.

20. A condenser, comprising the heat exchanger of claim 1 and no fan.
